(19) United States
(12) Patent Application Publication
(10) Pub. No.: US 2006/0258525 A1
(43) Pub. Date: Nov. 16, 2006

(54) Transparent silica glass luminescent material and process for producing the same

(76) Inventors: Takashi Uchino, Hyogo (JP); Tomoko Yamada, Hyogo (JP)

Correspondence Address: POSZ LAW GROUP, PLC, 12040 SOUTH LAKES DRIVE, SUITE 101, RESTON, VA, 20191, US

(21) Appl. No.: 10/569,822

(22) PCT Filed: Aug. 27, 2004
(86) PCT No.: PCT/JP04/12373

§ 371 Date: Feb. 28, 2006

(30) Foreign Application Priority Data
Aug. 29, 2003 (JP) 2003-305634

(51) Int. Cl. C03B 19/09; C03C 3/06; C03B 19/01

(52) U.S. Cl. 501/54; 65/17.3

(57) ABSTRACT

It is an object of the present invention to provide a light emitting device of the next generation optical device having a broad emission property that a width at half maximum of an emission spectrum is large in a wavelength range of visible light and capable of recognizing white light emitting by photoluminescence (PL). In a baking process for baking a pressure molding formed by pressure molding of silica fine particles such as fumed silica, a baking temperature is made as not more than 1000° C., hydroxyl groups of the silica fine particles are sufficiently subjected to dehydration condensation reaction so that the particles becomes transparent, a structural defect generated in the process is held without being relaxed, and thus a silica glass is generated. The silica glass is employed as a fluorescent substance.

### TECHNICAL FIELD

The present invention relates to a transparent silica luminescent material and method for manufacturing the same, more specifically, it relates to a transparent silica glass which is generated from silica fine particles, has emission property broad in a wavelength range of visible light and is applicable to white light emitting device materials.

### BACKGROUND ART

In recent years, improvements in a visible short wavelength light emitting diode (LED) of a nitride semiconductor type have been advanced and a white LED using the diode has been developed in place of conventional illumination fixtures such as an electric bulb and fluorescent lamp. When the white LED is employed as illumination, there are merits that: power is saved, running cost is lowered, safety is enhanced and a life is lengthened, compared to an incandescent lamp or the fluorescent lamp; and it is unnecessary to use a toxic substance such as mercury as the fluorescent lamp.

When the white LED is realized, there are some choices. That is why light color of an LED becomes unique to a semiconductor crystal used for an LED chip by depending on a band gap and light color of a general LED becomes a single color such as red, green or blue. As a means for realizing the white LED, there is a means for gathering the red LED, green LED and blue LED and making all of the LED emit light at the same time. Further, the white LED is realized by combination of electro luminescence (EL) and photoluminescence (PL) and with a fluorescent substance using the blue LED and a rare earth element, or the like.

The white LED is realized with the fluorescent substance using the blue LED and the rare earth element as described above. Therefore, processing of the white LED becomes complicated by use of the rare earth element and problems are pointed out in terms of resource amounts and costs. Thus, a material for the next generation optical device is required which does not impact the environment at the time of disposal, of which manufacturing process is simpler than that of the conventional white LED and which can meet the requirements of low-cost, energy savings and preservation of the environment. (Patent Document 1 and Non-Patent Document 1)

A sintering process of fine particles is disclosed in the Documents regarding the silica glass as listed below, but a sintering process regarding a transparent silica glass is not disclosed therein. Further, emission property (white light emitting) are not disclosed therein. (Patent Documents Nos. 2 to 4 and Non-Patent Documents Nos. 2 to 4)
[Patent Document 1]: Japanese Published Unexamined Patent Application No. 2001-156336
[Patent Document 2]: Japanese Published Unexamined Patent Application No. H02-133329
[Patent Document 3]: Japanese Published Unexamined Patent Application No. 2002-211935
[Patent Document 4]: Japanese Published Unexamined Patent Application No. H01-201664
[Non-Patent Document 1]: MITSUBISHI CABLE INDUSTRIES, LTD. REPORT p. 35 to p. 40 (July, 2002)
[Non-Patent Document 2]: G. V. Chandrashekhar; Mat. Res. Soc. Symp. Proc. Vol. 73, p. 705 to p. 710 “DIELECTRIC PROPERTIES OF SOL-GEL SILICA GLASSES”
[Non-Patent Document 3]: Hiroshi Suzuki; Japan Ceramics Association Scientific Paper Vol. 100, No. 3, p. 272 to p. 275 (March 1992) “Fine structure control of porous silica glass using mono dispersion sphere-shaped silica particles)
[Non-Patent Document 4]: R. Clasen; Glastech. Ber. Vol. 61, No. 5, pp. 119-126 (May 1988) “Preparation of glass and ceramics by sintering colloidal particles deposited from the gas phase”

### DISCLOSURE OF THE INVENTION

[The Problem to be Solved]

It is an object of the present invention to provide a light emitting device of the next generation optical device capable of recognizing white light emitting by photoluminescence (PL). That is, the object is to develop an light emitting device having a broad emission property that a half bandwidth of an emission spectrum is large in a wavelength range of visible light, the emission property differing from a feature of an LED that a half bandwidth of an emission spectrum is small and single color property is high.

As a result of diligent research for a defect generation process of an amorphous structure of a silica glass by the inventors, the inventors found that a transparent silica glass manufactured with use of silica fine particles under a specific baking temperature condition has the broad emission property, in which the half bandwidth of the emission spectrum is large in the wavelength range of visible light, and completed the present invention.

[Means for Solving the Problem]

In the present invention, a pressure molding formed by pressure molding of silica fine particles is baked under a temperature condition that a structural defect is generated and held without being relaxed, and thus a transparent silica glass having a white emission property is manufactured.

In a general method for manufacturing a silica glass, a high temperature condition of 1800° C. or more is required for heating and fusion of silica fine particles generated by heating and fusion of quartz crystals or combustion of silicon tetrachloride under an oxygen-hydrogen flame.

On the other hand, in a method for manufacturing a silica glass according to the present invention, the silica glass is manufactured by solid phase reaction of silica fine particles without melting. More specifically, a pressure molding is baked under a lower temperature condition than the melting temperature after pressure molding with use of a reaction between surfaces of chemically active silicas, and thus the silica glass is manufactured with the structural defect generated and held without being relaxed.

Here, the pressure molding with use of a reaction between surfaces of chemically active silicas means that the silica fine particles are pressure molded and the pressure molding is formed. Moreover, it is difficult to pressure mold the silica fine particles and form the pressure molding at a pressure of 5 MPa or less.

A baking process is performed at a temperature in a range of 500-1400° C. and in a time range of 1 minute to 300 hours so that the structural defect is generated and held.

The reason for the baking at a lower temperature than the melting temperature of the general silica glass and for a long time will be explained below.

The silica fine particle usually contains a great number of hydroxyl groups (silanol). A defect structure that a silicon-oxygen bond is cleaved can be induced in a glass structure with use of a process for removing the hydroxyl groups by dehydration condensation reaction. A temperature of 200° C. or more is generally required to subject the silica glass fine particles to the dehydration reaction. Further, a temperature of 500° C. or more is required so that the hydroxyl groups between the silica glass fine particles are sufficiently dehydration-condensed.

However, when the pressure molding is baked at a temperature higher than 1400° C., atom movement is actively performed, and therefore the defect generated by the dehydration condensation reaction of the hydroxyl groups is relaxed.

Thereupon, a baking temperature of the pressure molding is made to range from 500° C. to 1400° C. so that the defect generated in the dehydration condensation process of the hydroxyl groups of the silica fine particles can be held without being relaxed.

The baking process is performed in a time range of 1 minute to 300 hours so that the dehydration condensation reaction of the hydroxyl groups of the silica fine particles is sufficiently performed. A water content of the general silica glass ranges from 300 ppm to 500 ppm. The baking time in a range of 1 minute to 300 hours is required in accordance with the baking temperature so that a water content of the silica glass according to the present invention is made to range from 300 ppm to 500 ppm.

In particular, the transparent silica glass that the baking is performed at a temperature near 980° C. and in a time range of 120 to 200 hours has a broad spectrum property that ranges the whole wavelength range of visible light as a peak at a wavelength of 520 nm and that a full width at half maximum (FWHM) is approximately 200 nm, and further has a white emission property that a photoluminescence (PL) intensity is so high that observation by the naked eye is possible.

As the silica fine particle used for the method for manufacturing the transparent silica glass according to the present invention, fumed silica is employed which is artificial amorphous silicon dioxide and is a high-purity super fine particle having a particle size of several nm to tens nm. That is why the solid phase reaction is smoothly performed because of the highly reactive surface of the fumed silica.

The particle size of the fumed silica is 1 to 100 nm, desirably 5 nm to 100 nm and more desirably 5 nm to 50 nm. That is why the structural defect is likely to be generated when the particle size is small. Moreover, a particle size of fumed silica on the current market is 7 nm to 50 nm.

When the baking is performed at a temperature in a range of 1000° C. to 1400° C. and in a time range of several minutes to 100 hours, the transparent silica glass can be obtained which has a first emission peak in a wavelength of 400 nm to 500 nm, a second emission peak in a wavelength of 650 nm and emission property broad in the wavelength range of visible light in a spectrum of the photoluminescence (PL). The transparent silica glass has a reddish white emission property by an emission peak at a wavelength of 650 nm.

When the silica fine particles are mixed with inorganic material particles having semi-conductivity and/or conductivity to be pressure molded and baked, the defect is likely to be generated and a silica glass having a red type emission property can be obtained. For example, when the silica fine particles are mixed with carbon, silicon or the like, a pink silica glass having a red emission property is generated.

[The Effect of the Invention]

A transparent silica glass luminescent material according to the present invention has an effect that a width at half maximum of an emission spectrum is large in a wavelength range of visible light and a broad emission is performed. Further, a method for manufacturing the transparent silica glass luminescent material according to the present invention is a simple manufacturing process constituted by only pressure molding and baking, and the method has an effect that the transparent silica glass luminescent material can be easily manufactured at a low baking temperature.

Further, the transparent silica glass luminescent material according to the present invention is excellent in endurance and has an effect that emission property does not change over a long time (a few months).

The possibility is high that the transparent silica glass luminescent material is made practicable as a fluorescent material such as a white LED owing to the above-described emission property and manufacturing process.

### DESCRIPTION OF THE PREFERRED EMBODIMENTS

Best modes for carrying out the present invention will be explained below with reference to the accompanying drawings.

### First Embodiment

A method for manufacturing a transparent silica glass according to the present invention includes a pressurizing process for pressure molding silica fine particles and forming a pressure molding and a baking process for baking the pressure molding. The baking is performed under a temperature condition that a structural defect is generated and held without being relaxed. An embodiment of the manufacturing method will be explained below.

As the silica fine particle used for manufacturing the transparent silica glass, fumed silica, etc., is employed. Silicon tetrachloride gas is oxidized and hydrolyzed with a flame of 1100° C. to 1400° C. that a mixed gas of hydrogen and oxygen is burned, and thus the fumed silica is manufactured. The fumed silica is a sphere-shaped super fine particle that an average size of first particles is approximately 10 nm, and the main ingredient of the fumed silica is amorphous silicon dioxide (SiO₂). The fumed silica is a super fine particle and is manufactured by rapid cooling, thereby having a surface structure of high chemical activity.

It is desirable that an average size of first particles of fumed silica used for manufacturing of transparent silica glass is from several nm to tens nm. That is why, for example, in fumed silica of which an average size of first particles exceeds 100 nm, a chemical activity force of the surface is small and the fusion bond effect of the fumed silica during the pressure load as described below becomes small and therefore the fumed silica is unsuitable for the manufacturing of transparent silica glass.

Moreover, the fumed silica actually used is as follows.
Maker: Sigma, St. Louis, Mo., USA
Type number: S 5130
Particle size: 7 nm

Furthermore, each analysis value of impurities of standard fumed silica is indicated below.
Al203: 0.001% or less, Fe203: 0.0001% or less, Ti02: 0.001% or less

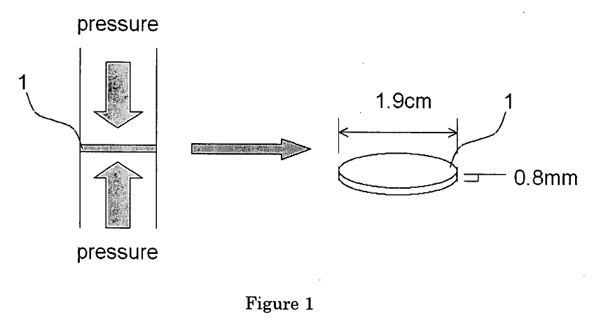

Next, the pressurizing process for pressure molding the silica fine particles and forming the pressure molding will be explained. FIG. 1 shows a conceptual diagram of the pressure molding of the silica fine particles. For example, the fumed silica is weighed by approximately 0.3 g and pressurized for 3 minutes at 529 MPa (150 kN to a pellet area 2.835 cm²) with use of a high-pressure molder, and thus the pellet of the silica glass can be manufactured.

Next, the baking process for baking the pressure molding will be explained. The above-described pressure molding of the fumed silica is made to be placed into an electric furnace to be baked under atmospheric pressure. For example, a baking temperature is made as 1000° C. or less and a baking time is made as 100 hours or more. That is why a part of the structural defect is relaxed and the defect cannot be sufficiently held when the baking temperature exceeds 1000° C. Further, that is why dehydration condensation of hydroxyl groups is insufficient and a defect of a sufficient concentration cannot be induced when the baking time is 100 hours or less even though the baking temperature is 1000° C. or less. As a tendency, the baking time becomes shorter as the baking temperature becomes higher, and the baking time becomes longer as the baking temperature becomes lower.

However, an optimum baking time depends on a baking temperature condition. That is why when the baking temperature is high, the defect is likely to be generated by a rapid advance of a dehydration condensation reaction of the hydroxyl groups, on the contrary, the defect is likely to be relaxed. Therefore, when the baking temperature is high, the baking time is required to be shortened.

As a result of diligent research, the inventors found that a baking time of 168 hours is desirable when the baking temperature is 980° C.

Here, the muffle furnace (Type number: KDF S70, Maker: Denken Co., Ltd.) is employed for baking of the pellet of the silica glass.

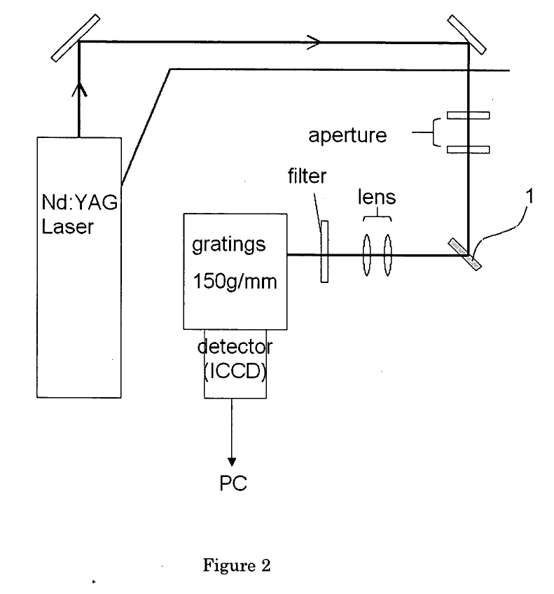

Emission property of the transparent silica glass manufactured by the above-described manufacturing method will be explained with reference to the drawings. FIG. 2 shows a block diagram of a measurement apparatus which measures photoluminescence (PL) of the transparent silica glass according to the present invention. Methods of a laser, a detector (ICCD: image intensifier CCD) and the like as shown in FIG. 2 will be described below.

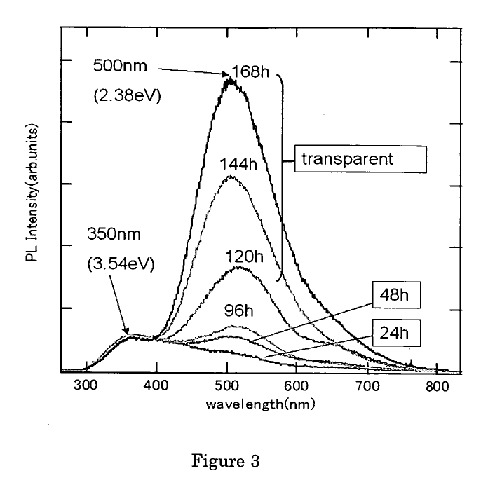

FIG. 3 shows a spectrum diagram of the photoluminescence (PL) of a transparent silica glass generated at a baking temperature of 980° C. FIG. 3 reveals that the transparent silica glass generated at the baking temperature of 980° C. has two main peaks, a peak near a wavelength of 350 nm and a peak near a wavelength of 520 nm, and further reveals that a value of the peak near the wavelength of 520 nm has a tendency to increase with an increase in the baking time. Furthermore, the more the generated silica glass becomes transparent, the larger an increase rate of the peak value increasing with an increase in the baking time becomes; and the longer the baking time becomes, the greater the tendency of the emission intensity of the photoluminescence becomes. Here, the emission intensity is normalized at photoluminescence spectrum intensity of a wavelength of 350 nm.

FIG. 3 reveals that when the baking temperature is 980° C., silica glasses generated by baking times of 120, 144 and 168 hours are transparent and each photoluminescence relative intensity of a wavelength of 520 nm to that of a wavelength of 350 nm is apparently greater than photoluminescence relative intensities of silica glasses generated by the other baking times.

Here, although not shown in FIG. 3, when the baking temperature is 980° C., a peak value of photoluminescence of a silica glass generated by a baking time of 192 hours is lower than that of the silica glass generated by the baking time of 168 hours. That is, there exist optimum baking times, in which the emission intensity becomes maximum, by every baking temperature. For example, when the fumed silica fine particles are pressure molded under the above-described condition and baked at the temperature of 980° C. as shown in the present embodiment, the optimum baking time is 168 hours. That is why the generated defect is relaxed and a defect concentration contributing to emission is reduced when the baking time is too long.

FIG. 3 reveals that the transparent silica glass according to the present invention has the peak of the emission at the wavelength of 520 nm and a broad emission property in which a full width at half maximum (FWHM) is approximately 200 nm in the spectrum of the photoluminescence. In actuality, when a laser beam having a weak energy density of 1 to 2 mJ/cm² is irradiated to the transparent silica glass generated by the baking temperature of 980° C. and the baking time of 168 hours, white light emitting arises.

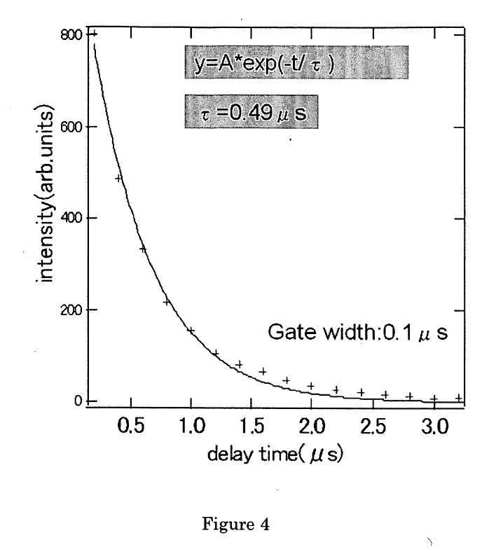

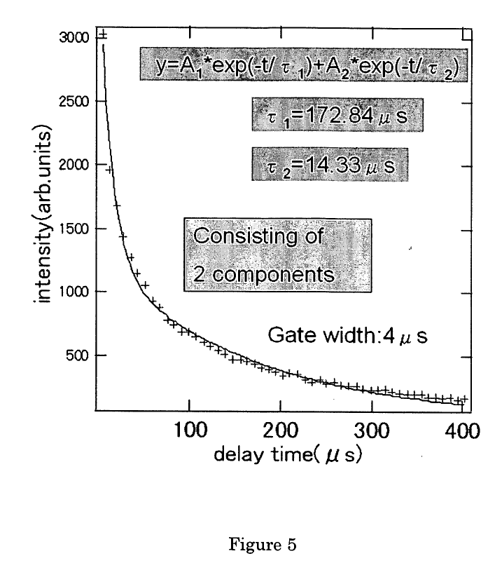

Regarding a emission decay time of the transparent silica glass according to the present invention, wavelength lights at two main peak values of the photoluminescence shown in FIG. 3 are selected and lives of these are measured. The measurement results will be respectively explained with reference to FIG. 4 and FIG. 5. FIG. 4 shows a photoluminescence decay time of an emission of a wavelength of the 350 nm range of the transparent silica glass generated by the baking temperature of 980° C. and the baking time of 168 hours. Similarly, FIG. 5 shows a photoluminescence decay time of an emission of a wavelength of the 520 nm range. FIG. 4 shows an attenuation behavior of an emission species having a fluorescent life on an order of sub-micro seconds of approximately 0.5 micro seconds, whereas FIG. 5 shows an attenuation behavior of an emission species having a decay time on an order of several micro seconds. This reveals that the decay time of the wavelength of 520 nm taking a leading part in broad emission wavelengths contributing to the emission of the transparent silica glass is much longer than the decay times of the other wavelengths. Therefore, the white light emitting can be recognized by the naked eye.

FIG. 5 shows that an attenuating process of the emission is represented by two exponential functions, and a result of overlap of experiment data reveals that the attenuating process of the emission can be accurately represented by the following exponential function called a stretched exponential function.

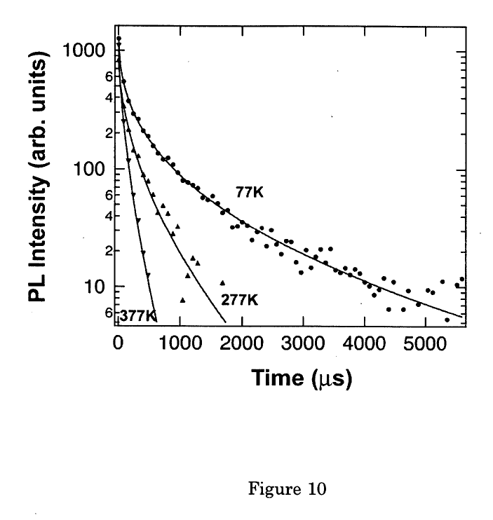

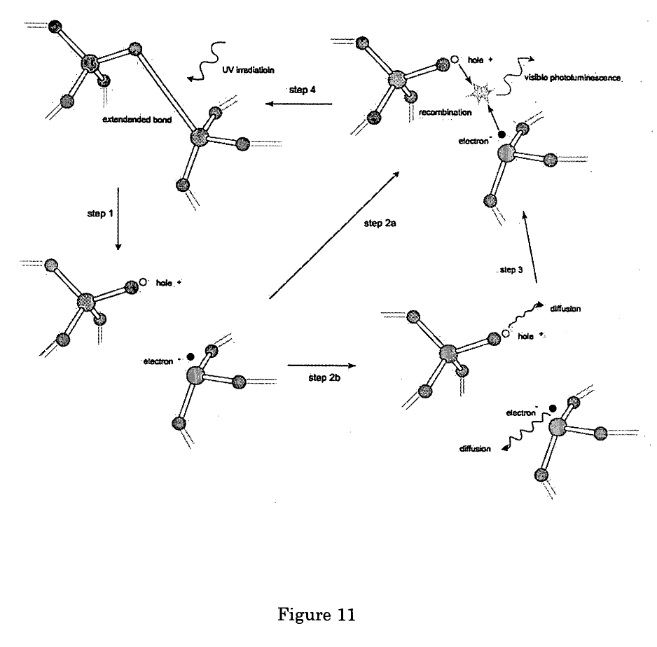

FIG. 10 is a graph diagram showing temperature dependency of time decay of the emission intensity at 510 nm of a sample obtained by the baking temperature of 980° C. and the baking time of 168 hours. Here, the solid line indicates a result of fitting with the use of the stretched exponential function indicated in Expression 1.
I=I₀ exp(−(t/τ)^{β}) [Expression 1]

Expression 1 differs from the usual exponential function in a point that a term, β, called stretched parameter is added. When the term β is 1, the expression corresponds to the usual exponential function. Expression 1 indicates that as the term β becomes smaller than 1, a distribution width of the emission decay time increases.

A fitting by use of the two exponential functions shown in FIG. 5 is optimum for a case that a decay profile consists of two components. Regarding the stretched exponential function shown in FIG. 10, it is assumed that a decay time has a great number of components not only two components. The term β is approximately 0.5 in the sample, and therefore it is possible to understand that the distribution width of the emission decay time of the sample in the emission process is so large as to range from a short decay time (several μ seconds) to a long decay time (several thousands μ seconds). A reason why the distribution width of the decay time is large as this is considered below.

(1) Free electrons and holes are generated in the sample by ultraviolet ray irradiation.

(2) The generated free electrons and holes diffuse in the sample.

(3) In a diffusion step, the free electrons recombine with the holes, consequently, the emission can be observed.

(4) A time width from the generation and diffusion to recombination of the free electrons and holes appears as a decay time distribution.

FIG. 11 schematically shows the above-described processes. That is, it is possible to understand that the emission process of the sample lasts for a long time without deactivation by the cycle of each individual step indicated below. Each step will be explained below.

Step 1 shows a process for generating the free electrons and holes with optical excitation by the ultraviolet ray irradiation to a state that the defect is held without being relaxed (the state is represented by the extended Si—O bond in FIG. 11), the state being anticipated to exist in the transparent silica glass according to the present invention. Moreover, the extended Si—O bond is cut off in the process.

Step 2a shows a process that the generated free electrons and holes recombine with each other there to emit visible light.

Step 2b shows a process that the generated free electrons and holes diffuse in the sample before recombination.

Moreover, the free electrons and holes generated in Step 1 proceed to either of Step 2a or Step 2b.

Step 3 shows a process that the free electrons and holes diffused in Step 2b recombine with each other at a certain defect site to emit visible light.

Steps 2a, 2b and 3 show the process that the generated free electrons and holes recombine with each other there or via the diffusion to emit visible light.

Step 4 shows a process that a defect sight once disappears by the cut-off of the extended Si—O bond in Step 1 and appears again owing to a recovery of the Si—O bond by re-bonding of the free electrons and holes. In other words, a defect structure returns owing to the recovery of the Si—O bond by re-bonding of the free electrons and holes.

In the above-described model, as the temperature becomes lower, it becomes difficult that the diffusion arises, and long life components increase. An examination of the attenuating process of the emission between liquid nitrogen temperatures of −200° C. (77 k) and 100° C. (377 k) reveals that the life becomes longer as the temperature becomes lower. Such stretched exponential function attenuation of the emission intensity regarding the silica glass has not been reported. Therefore, it is possible to understand that the emission of the sample deserves a novel emission phenomenon resulting from a specific defect state generated by solid phase sintering reaction of silica fine particles of nano-size and optical excitation electrons and holes generated by the defect state.

### Embodiment 2

Emission property of a silica glass manufactured at a baking temperature in a range of 1000 to 14000C will be explained as another embodiment.

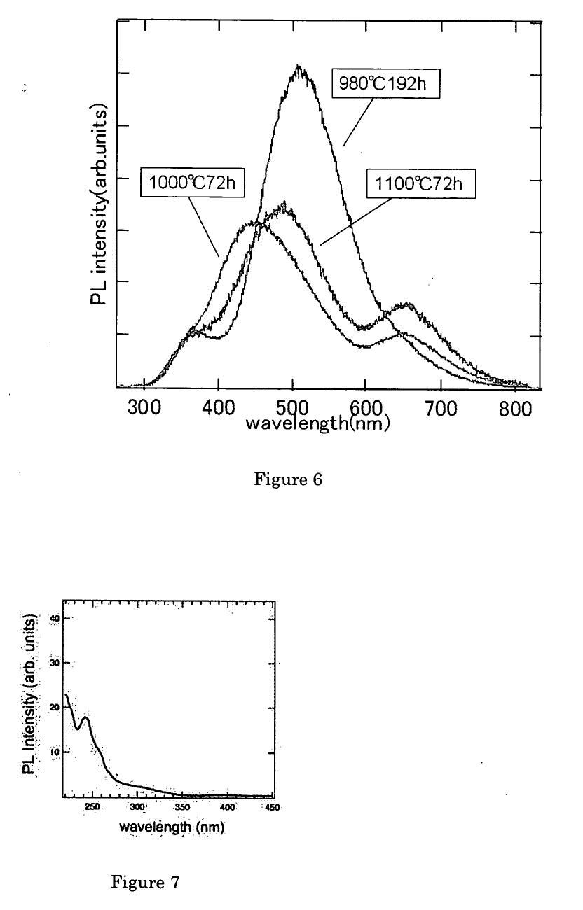

FIG. 6 shows a spectrum diagram of the photoluminescence (PL) (silica glasses baked at 980° C., 1000° C. and 1100° C.). FIG. 6 reveals that a transparent silica glass can be generated when the baking temperature is more than 1000° C., the transparent silica glass having a first emission peak in a wavelength of 400 nm to 520 nm, a second emission peak in a wavelength of 650 nm and emission property broad in the wavelength range of visible light in a spectrum of photoluminescence (PL).

### Embodiment 3

When the silica fine particles are mixed with inorganic material particles having semi-conductivity and/or conductivity to be pressure molded and baked, the defect is likely to be generated and a silica glass having a red type emission property can be obtained. By use of which, a transparent silica glass having light emitting color other than white light emitting can be generated. For example, when the silica fine particles are mixed with carbon, silicon or the like, a pink silica glass having a red emission property is generated.

### Embodiment 4

FIG. 7 shows a result of measurement of an emission excitation spectrum for searching an optimum wavelength of an excitation light regarding the emission property of the transparent silica glass according to the present invention. The excitation spectrum of an emission of 510 nm is measured, the wavelength of 510 nm having a higher peak (the photoluminescence intensity is higher) between the two peaks appearing in the spectra diagram (see FIG. 3) of the photoluminescence of the sample (transparent silica glass) generated by the baking temperature of 980° C. and the baking time of 168 hours. FIG. 7 shows that the photoluminescence excitation spectrum of the emission has a peak near 240 nm. Since an emission intensity becomes strongest at a peak position of an excitation spectrum, the optimum excitation wavelength of the sample is 240 nm.

Moreover, since the intensity of the photoluminescence excitation spectrum is raised at a short wavelength side from the peak, it can be expected that even the excitation of a shorter wavelength can obtain an emission intensity equal to that of the excitation at 240 nm.

### Embodiment 5

Next, a transparent silica glass that can be manufactured where the emission intensity of a short wavelength range is increased further by application of pre-heat treatment in the manufacturing process of the transparent silica glass according to the present invention, will be explained below.

In the manufacturing process of the transparent silica glass in Embodiments 1 and 2, the pressure molding is manufactured without the pre-heat treatment of the fumed silica and the transparent silica glass is manufactured via the pre-heat treatment of the pressure molding. In the present embodiment, newly, the fumed silica is subjected to the pre-heat treatment at a temperature of 1000° C. and for 2 hours so that a pressure molding is manufactured by using the sample, and the pressure molding is further subjected to the pre-heat treatment so that the transparent silica glass is manufactured.

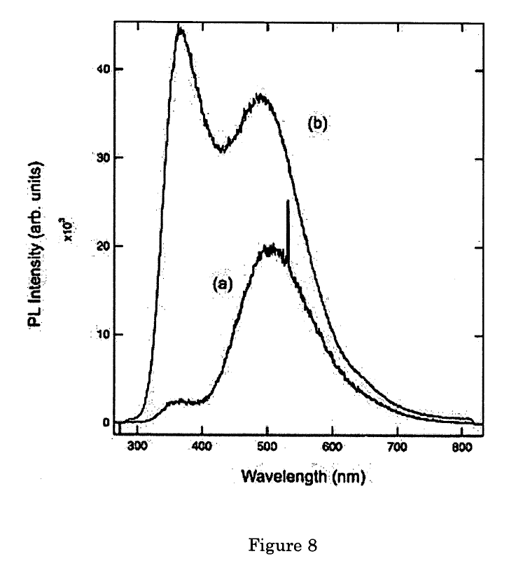

FIG. 8 shows an emission spectrum of the transparent silica glass subjected to the pre-heat treatment. In FIG. 8, the curve (a) shows an emission spectrum of a sample manufactured without the pre-heat treatment and the curve (b) shows the emission spectrum of the sample manufactured via the pre-heat treatment. FIG. 8 reveals that the emission intensity of a short wavelength component (a peak appears at 350 nm) becomes higher in the emission spectrum of the transparent silica glass subjected to the pre-heat treatment.

FIG. 8 further reveals that the conventional emission intensity near 510 nm becomes about twice by the pre-heat treatment.

### Embodiment 6

In addition, a pressure molding pressure to the sample is reduced and the pressure molding is manufactured so that a transparent silica glass can be manufactured with an increase in the emission intensity of the short wavelength range, will be explained below.

In the manufacturing process of the transparent silica glass in Embodiments 1 and 2, a pressure for manufacturing of the pressure molding is fixed at 529 MPa. In the present embodiment, the pressure molding is manufactured at a pressure of about one-thirtieth of the above pressure, 18 MPa, so that a pressurization effect to the emission phenomenon, a pressurization dependency of the emission phenomenon, can be confirmed.

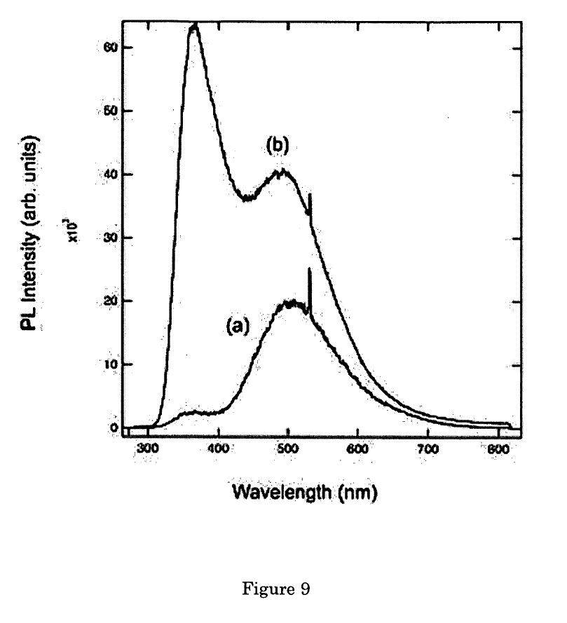

FIG. 9 shows an emission spectrum of the transparent silica glass manufactured at the low pressure molding pressure. In FIG. 9, the curve (a) shows an emission spectrum of the conventional sample and the curve (b) shows a spectrum of the sample manufactured at the low pressure molding pressure. Although a time until the silica fine particles become transparent takes 200 hours or more, which is twice compared with a time until the silica fine particles become transparent under no decompression, FIG. 9 reveals that the emission intensity of the short wavelength component (a peak appears at 350 nm) in the emission spectrum of the sample is high similar to the transparent silica glass manufactured via the pre-heat treatment.

FIG. 9 further reveals that the emission intensity near 500 nm becomes about twice by manufacturing of the sample at the low pressure molding pressure, similar to the transparent silica glass manufacture by application of the pre-heat treatment.

Here, the reason why a phenomenon arises will be explained below, the phenomenon indicating that an increase in the emission intensity of the short wavelength range by the pre-heat treatment and reduction of the pressure molding pressure respectively shown in Embodiments 5 and 6.

At first, the phenomenon will be explained that an increase in the emission intensity of the short wavelength range by the reduction of the pressure molding pressure in the manufacturing process of the transparent silica glass.

In the pressurizing process for pressure molding the silica fine particles and forming the pressure molding, as the pressure molding pressure becomes lower, it is expected that a distance between particles in the inside of the molding becomes longer. Therefore, a longer time is required until inter particle reaction actively arises between the silica fine particles. Consequently, it is considered that a reaction time until the silica fine particles become transparent becomes longer in the case of the transparent silica glass manufactured at the low pressure molding pressure.

When the transparent silica glass is manufactured at the low pressure molding pressure, the silica fine particles are baked at the temperature of 1000° C. for a long time before the inter particle reaction arises. Therefore, it can be considered that most of the hydroxyl groups are subjected to dehydration condensation reaction (on the self surfaces) before the inter particle reactions of the hydroxyl groups on the particle surfaces arise. It is considered that the similar effect (dehydration condensation reaction on the self surfaces) can be obtained by preheating of fumed silica as the case that the transparent silica glass is manufactured via the pre-heat treatment. Therefore, it can be considered that the same emission spectrum can be obtained in the both cases of manufacturing by application of the pre-heat treatment and manufacturing at the low pressure molding pressure because a clearing reaction is made to arise with a low hydroxyl group concentration of the fine particle surface.

It is expected that the inter particle reaction for making the silica fine particles transparent depends on the condensation of the hydroxyl groups between the surfaces of the particles. That is, when there are few hydroxyl groups as a reaction activity point, it becomes difficult that a structural relaxation between the particles arises, compared to the case that there are many hydroxyl groups. Therefore, it can be expected that the state, in which the defect is held without being relaxed, can be more easily realized, the state taking a leading part of the emission in the transparent silica glass according to the present invention. Thus, the increase of the emission intensity can be explained.

An emission peak intensity of 350 nm especially increases in Embodiments 5 and 6. This indicates that a structural deformation of the defect contributing to the emission of 350 nm is larger than that of the defect contributing to the emission of 510 nm. That is, a relaxation state of the defect in the obtained transparent silica glass can be changed by controlling a starting concentration of the hydroxyl group on the surface of the fine particle even if the fine particles having the same size are used, and consequently a shape of the emission spectrum of the transparent silica glass and the whole emission intensity can be controlled. This is indicated in the result of Embodiments 5 and 6.

Moreover, it is confirmed that neither a change nor a degradation of the emission property of the transparent silica glass according to the present invention with the passage of time arises even if the transparent silica glass is kept in the state of a usual storage state for one year or more.

The methods of the measurement apparatuses used for measurement of the photoluminescence (PL) of the transparent silica glass according to the present invention will be listed below.
1) Irradiation Laser Source

Pulsed Nd: YAG laser

(Spectra Physics INDI-40)
excitation wavelength: 266 nm
pulse width: 5-8 ns
repetition rate: 10 Hz
beam diameter <10 mm
laser energy: 1-2 mJ
2) Monochromator

Action Research SpectraPro 300i Grating
150/mm Gratings (500 nm Blaze)
3) Detector

ICCD

(Princeton Instruments PI-MAX 1024RB)
CCD format 1024×256 imaging pixels
peak QE minimum 15-20%
gate time 9 ns

Availability in the Industry

A transparent silica glass luminescent material according to the present invention is manufactured by a simple process that silica fine particles are pressure molded and baked and has a property indicating an emission broad in a wavelength range of visible light, thereby can be used as a luminescent material such as a white light emitting device.

### BRIEF DESCRIPTION OF THE DRAWINGS

[FIG. 1] a conceptual diagram of pressure molding of silica fine particles

[FIG. 2] a block diagram of a measurement apparatus of photoluminescence (PL)

[FIG. 3] a spectrum diagram of the photoluminescence (PL) (a baking time is defined as a parameter regarding a silica glass baked at a temperature of 980° C.)

[FIG. 4] a time analysis measurement diagram of a photoluminescence band (wavelength light of 350 nm)

[FIG. 5] a time analysis measurement diagram of a photoluminescence band (wavelength light of 520 nm)

[FIG. 6] a spectrum diagram of photoluminescence (silica glasses baked at temperatures of 980° C., 1000° C. and 1100° C.)

[FIG. 7] a photoluminescence excitation spectrum diagram of a sample baked at temperatures of 980° C. and for 168 hours (measurement by change of a wavelength of an excitation light source during the observation of an emission intensity of 510 nm)

[FIG. 8] an emission spectrum of a transparent silica glass subjected to the pre-heat treatment (the curve (a) shows an emission spectrum of a sample manufactured without the pre-heat treatment and the curve (b) shows the emission spectrum of the sample manufactured with the pre-heat treatment)

[FIG. 9] an emission spectrum of a transparent silica glass manufactured at a low pressure molding pressure (the curve (a) shows an emission spectrum of the conventional sample and the curve (b) shows a spectrum of the sample manufactured at the low pressure molding pressure)

[FIG. 10] a graph diagram showing temperature dependence of time decay of the emission intensity at 510 nm of a sample obtained by a baking temperature of 980° C. and a baking time of 168 hours (the solid line indicates a result of fitting with use of a stretched exponential function)

[FIG. 11] a diagram showing an emission mechanism of the transparent silica glass

### DENOTATION OF THE REFERENCE NUMBER

1 silica glass sample

1. A method for manufacturing a transparent silica glass luminescent material comprising:
a pressurizing process for pressure molding silica fine particles and forming a pressure molding; and
a baking process for baking the pressure molding under a temperature condition that a structural defect is generated and held without being relaxed.

2. A method for manufacturing a transparent silica glass luminescent material comprising:
a pressurizing process for pressure molding silica fine particles and forming a pressure molding; and
a baking process for baking the pressure molding at a temperature in a range of 500° C. to 1400° C. and in a time range of 100 minutes to 300 hours.

3. A method for manufacturing a transparent silica glass luminescent material comprising:
a pressurizing process for pressure molding silica fine particles and forming a pressure molding; and
a baking process for baking the pressure molding at a temperature in a range of 900° C. to 1000° C. and in a time range of 120 to 200 hours.

4. A method for manufacturing a transparent silica glass luminescent material according to claim 1, wherein the silica fine particle is fumed silica which is synthesized by a vapor phase method and is a high-purity nano-size silica fine particle having a particle size in a range of 1 nm to 100 nm.

5. A method for manufacturing a transparent silica glass luminescent material according to claim 1, wherein silica fine particles are mixed with inorganic material particles having semi-conductivity and/or conductivity to be pressure molded and baked.

6. A method for manufacturing a transparent silica glass luminescent material according to claim 4, further comprising a pre-heat treatment process for subjecting fumed silica to heat treatment at 1000° C. and for 2 hours before the pressurizing process for forming the pressure molding.

7. A silica glass luminescent material having an emission peak in a wavelength of 500 nm to 520 nm and a broad emission property, in which a full width at half maximum (FWHM) is 200 nm to 300 nm, in a spectrum of photoluminescence (PL).

8. A silica glass luminescent material having a first emission peak in a wavelength of 400 nm to 520 nm, having a second emission peak in a wavelength of 640 nm to 660 nm and indicating a broad emission, in which a wavelength ranges from 300 nm to 800 nm in a wavelength range of visible light, in a spectrum of photoluminescence (PL).

9. A silica glass luminescent material, wherein the silica glass luminescent material according to claim 1 has transparency that a visible light permeation rate at a wavelength of 600 nm is not less than 75%.

10. A light emitting device, wherein a transparent silica glass luminescent material obtained by a manufacturing method according to claim 1 is employed as a fluorescent substance.

11. A light emitting device, wherein a silica glass luminescent material according to claim 7 is employed as a fluorescent substance.
